(19) United States
(12) Patent Application Publication
(10) Pub. No.: US 2025/0109072 A1
(43) Pub. Date: Apr. 3, 2025

(54) CERAMIC ARTICLES AND METHODS FOR FORMING SAME

(71) Applicant: SAINT-GOBAIN CERAMICS & PLASTICS, INC., Worcester, MA (US)

(72) Inventor: Brian C. LACOURSE, Pepperell, MA (US)

(21) Appl. No.: 18/899,950

(22) Filed: Sep. 27, 2024

Related U.S. Application Data
(60) Provisional application No. 63/586,654, filed on Sep. 29, 2023.

(51) Int. Cl. C04B 35/117

(52) U.S. Cl. CPC C04B 35/117; C04B 2235/3206; C04B 2235/3208; C04B 2235/3222; C04B 2235/3418; C04B 2235/763

(57) ABSTRACT

A ceramic article may include a body including a primary phase including alumina and a secondary phase. The body may further include a content of calcium oxide. In an embodiment, the body may include a content of magnesium oxide lower than the content of calcium oxide.

### CROSS-REFERENCE TO RELATED APPLICATION(S)

This application claims priority under 35 U.S.C. § 119(e) to U.S. Provisional Application No. 63/586,654, entitled “REFRACTORY ARTICLES AND METHODS FOR FORMING SAME,” by Brian C. LACOURSE, filed Sep. 29, 2023, which is assigned to the current assignee hereof and incorporated herein by reference in its entirety.

### FIELD OF THE DISCLOSURE

The present application relates in general to ceramic articles including alumina (Al₂O₃) and methods of forming the same.

### DESCRIPTION OF THE RELATED ART

Ceramic articles may be used under harsh conditions. For instance, certain ceramic articles may be used as a lining material of ceramic chutes, bins, hoppers, and the like to handle abrasive bulk materials and required to withstand wear from erosion to heavy impact by dense abrasive materials. The industry continues to demand improved ceramic articles.

### BRIEF DESCRIPTION OF THE DRAWINGS

Embodiments are illustrated by way of example and are not limited in the accompanying figures.

FIG. 1 includes a scanning electron microscope image of a portion of a ceramic article according to an embodiment.

FIG. 2 includes a flow chart illustrating a process for forming a ceramic article according to an embodiment.

FIG. 3 includes a graph illustrating contents of amorphous phases of ceramic articles.

FIG. 4 includes a graph illustrating wear rates of ceramic articles.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

The following is directed towards ceramic articles and methods of forming ceramic articles. Ceramic articles described in embodiments herein may have improved wear resistance and mechanical properties and be suitable for use in various harsh conditions including applications involving high temperatures, high abrasion, high corrosion, or the like, or any combination thereof. The ceramic articles may take any form desired by applications. For example, the ceramic articles may be formed into tiles or have regular or irregular shapes for suitable uses. Further exemplary applications may include lining materials for furnace, chutes, bins, hoppers, or the like, or any combination thereof, construction materials, kiln furniture, electrical insulation, armor, crucibles, setters, or the like, or any combination thereof.

Embodiments may relate to methods of forming the ceramic articles including using a composition within the CaO—MgO—Al₂O₃—SiO₂ system that may form a liquid phase at a high temperature and facilitate formation of a sintered body including alumina. In an embodiment, sintering may be performed with carefully controlled heating and cooling processes to allow formation of ceramic articles with improved properties. In another embodiment, the liquid-forming composition may have a particular chemistry that may facilitate a low melting temperature and fast wetting ability, which may allow liquid phase sintering to be performed at a relatively low temperature and ceramic bodies be formed with high density and improved properties of the ceramic articles.

In an embodiment, the ceramic article may include a body including alumina (Al₂O₃). In an aspect, alumina may be in a major content (i.e., greater than 50 wt. %) for the weight of the body. In a further aspect, the body may include a particular content of alumina that may facilitate improved properties of the ceramic article. In an example, the body may include greater than 60 wt. %, greater than 70 wt. %, or even greater than 80 wt. % of alumina for the weight of the body. In a particular example, the body may include at least 83 wt. % of alumina for the weight of the body, such as at least 85 wt. % of alumina, at least 87 wt. %, at least 89 wt. %, at least 90 wt. %, or at least 91 wt. % for the weight of the body. Additionally or alternatively, the body may include not greater than 96 wt. % of alumina for the weight of the body, such as not greater than 94 wt. %, not greater than 93 wt. %, not greater than 92 wt. %, not greater than 91 wt. %, or not greater than 90 wt. % of alumina for the weight of the body. Moreover, the body may include a content of alumina in a range including any of the minimum and maximum percentages noted herein. The content of alumina can be determined using Inductively coupled Plasma (ICP) analysis.

In another embodiment, alumina may be present in a crystalline phase. For example, the body may include corundum. In another example, majority of alumina (i.e., greater than 50 wt. %) may be present in the crystalline phase, such as at least 60 wt. %, at least 70 wt. %, at least 80 wt. %, at least 85 wt. %, at least 90 wt. %, at least 93 wt. %, or at least 95 wt. % of alumina may be present in the crystalline phase. In a particular example, essentially all of alumina (i.e., at least 97 wt. %) may be present in the crystalline phase. In this disclosure, the content of a crystalline phase may be determined by using X-ray diffraction analysis, Electron Backscatter Diffraction analysis, and/or mass balance based on contents of other components of the body.

In another embodiment, the body may include a primary phase including alumina. In a particular embodiment, the primary phase may include crystalline alumina, such as corundum. In a further embodiment, the primary phase may be in a particular content that can facilitate improved properties of the ceramic articles. For example, the primary phase may be at least 70 wt. % for the weight of the body, such as at least 73 wt. %, at least 75 wt. %, at least 77 wt. %, at least 80 wt. %, at least 82 wt. %, at least 84 wt. %, at least 86 wt. %, at least 88 wt. %, or at least 90 wt. % for the weight of the body. Additionally or alternatively, the primary phase may be not greater than 93 wt. %, not greater than 92 wt. %, not greater than 91 wt. %, not greater than 90 wt. %, not greater than 89 wt. %, not greater than 88 wt. %, not greater than 86 wt. %, not greater than 85 wt. %, not greater than 83 wt. %, not greater than 81 wt. %, not greater than 78 wt. %, or not greater than 75 wt. % for the weight of the body. Moreover, the body may include the primary phase in a content including any of the minimum and maximum percentages noted herein. In another embodiment, the primary phase may be a crystalline phase. In a further example, the primary phase may consist essentially of crystalline alumina. In a particular example, the body may include a corundum phase as the primary phase. In still another embodiment, the body may include corundum in any of the contents described with respect to the primary phase. In yet another example, a minor amount of alumina may be present in a secondary phase of the body. The secondary phase is described in detail later in this disclosure.

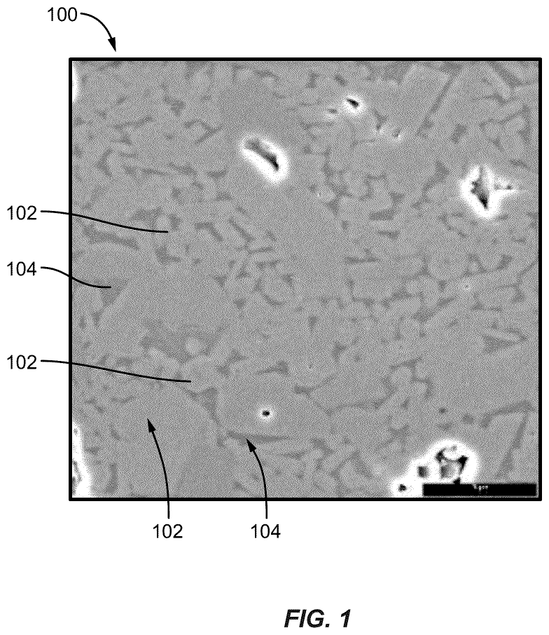

FIG. 1 includes an SEM image of a portion of the body 100 of a representative ceramic article including crystalline alumina including grains 102. As demonstrated, crystalline alumina may form the primary phase of the body 100. In an embodiment, the body may include alumina grains 102 having a particular average grain size that may facilitate improved properties of the ceramic articles. For example, the alumina grains may have an average grain size of greater than 2 microns, such as at least 2.2 microns, at least 2.4 microns, at least 2.6 microns, at least 2.8 microns, at least 2.9 microns, at least 3 microns, at least 3.1 microns, at least 3.3 microns, at least 3.5 microns, at least 3.7 microns, at least 3.8 microns, at least 3.9 microns, or at least 4 microns. Additionally or alternatively, the average alumina grain size may be at most 5.6 microns, at most 5.4 microns, at most 5.1 microns, at most 4.8 microns, at most 4.6 microns, at most 4.3 microns, at most 4.1 microns, at most 3.9 microns, at most 3.8 microns, at most 3.6 microns, at most 3.5 microns, at most 3.4 microns, at most 3.3 microns, at most 3.2 microns, at most 3.1 microns, or at most 3 microns. Moreover, the body may include an average grain size of alumina grains in a range including any of the minimum and maximum values noted herein. The average grain size may be determined by using digital image analysis and/or the linear intercept method to measure a statistically significant amount of grains from at least 3 different SEM images of the body.

In an embodiment, the body may include a maximum grain size of alumina grains that may facilitate improved properties of the ceramic articles. For example, the alumina grains may have a maximum grain size of greater than 2.5 microns, such as at least 2.6 microns, at least 2.8 microns, at least 3 microns, at least 3.3 microns, at least 3.5 microns, at least 3.7 microns, at least 3.8 microns, at least 3.9 microns, at least 4 microns, at least 4.2 microns, at least 4.5 microns, at least 4.7 microns, at least 4.9 microns, at least 5.2 microns, at least 5.5 microns, at least 5.7 microns, at least 5.8 microns, or at least 6 microns. Additionally or alternatively, the maximum grain size of alumina grains may be not greater than 20 microns, not greater than 19 microns, not greater than 18 microns, not greater than 17 microns, not greater than 16 microns, not greater than 15 microns, not greater than 14 microns, not greater than 13 microns, not greater than 12 microns, not greater than 10 microns, not greater than 9 microns, not greater than 8.6 microns, not greater than 8.3 microns, not greater than 8 microns, not greater than 7.8 microns, not greater than 7.5 microns, not greater than 7.2 microns, not greater than 7 microns, not greater than 6.8 microns, not greater than 6.6 microns, not greater than 6.4 microns, not greater than 6.2 microns, not greater than 6 microns, not greater than 5.8 microns, not greater than 5.6 microns, not greater than 5.4 microns, or not greater than 5.2 microns. Moreover, the body may include a maximum grain size of alumina grains in a range including any of the minimum and maximum values noted herein. The maximum grain size may be determined using digital image analysis and/or the linear intercept method to measure grains from at least 3 different SEM images of the body.

In an embodiment, the body may further include oxides other than alumina. For example, the body may include one or more of an alkaline earth metal oxide, an alkali metal oxide, silica (SiO₂), TiO₂, Fe₂O₃, ZrO₂, or any combination thereof. In a particular example, the body may include an alkaline earth metal oxide including calcium oxide (CaO) and magnesium oxide (MgO). In another particular example, the body may include silica. In another example, the body may include an unavoidable impurity, which may be due to the use of a starting material containing an unavoidable impurity. An example of unavoidable impurity may include BaO, TiO₂, Fe₂O₃, ZrO₂, SrO, one or more alkali metal oxides, or any combination thereof. In a further example, the body may include a total content of not greater than 1 wt. % or not greater than 0.5 wt. % of unavoidable impurity for a total weight of the body. In another example, the body may be essentially free of BaO, TiO₂, Fe₂O₃, ZrO₂, zircon, B₂O₃, a rare earth oxide, SrO, an alkali metal oxide, or any combination thereof.

In another embodiment, the body may include a secondary phase including one or more oxides. For example, the secondary phase may include one or more of an alkaline earth metal oxide, an alkali metal oxide, Al₂O₃, SiO₂, TiO₂, Fe₂O₃, ZrO₂, or any combination thereof. In a particular example, the secondary phase may include one or more oxides including calcium, magnesium, silicon, aluminum, or any combination thereof. Briefly turning to FIG. 1, the body 100 may include a secondary phase 104.

In an embodiment, the secondary phase may include an amorphous phase. In a further embodiment, the body may include an amorphous phase including one or more of calcium oxide, magnesium oxide, silica, alumina, or any combination thereof. In an example, the amorphous phase may include one or more or all of calcium oxide, magnesium oxide, silica, and alumina. In a further example, the amorphous phase may include one or more oxides including Ca, Mg, Si, Al, or any combination thereof. In a further example, the amorphous phase may include one or more of elements Ca, Mg, Si, Al, and O. In some instances, the amorphous phase may include an element from an impurity.

In an embodiment, the body may include a particular content of the amorphous phase that may facilitate improved properties of the ceramic article. In an aspect, the body may include at least 6.7 vol % of the amorphous phase for the volume of the body, such as at least 6.9 vol %, at least 7 vol %, at least 7.2 vol %, at least 7.5 vol %, at least 7.7 vol %, at least 7.9 vol %, at least 8 vol %, at least 8.2 vol %, at least 8.4 vol %, at least 8.5 vol %, at least 8.7 vol %, at least 8.8 vol %, at least 9 vol %, at least 9.2 vol %, at least 9.4 vol %, at least 9.5 vol %, at least 9.6 vol %, at least 9.8 vol %, at least 9.9 vol %, at least 10 vol %, at least 10.2 vol %, at least 10.3 vol %, at least 10.4 vol %, or at least 10.5 vol % for the volume of the body. In another aspect, the content of the amorphous phase may be not greater than 17.5 vol %, not greater than 16 vol %, not greater than 15.5 vol %, not greater than 14 vol %, not greater than 13.5 vol %, not greater than 12 vol %, not greater than 11 vol %, not greater than 10.5 vol %, or not greater than 10 vol % for the volume of the body. Moreover, the body may include an amorphous phase in a content including any of the minimum and maximum percentages noted herein. The content of the amorphous phase may be determined by using electron backscatter diffraction (EBSD) analysis followed by digital image analysis. The EBSD analysis can be performed at 20 KV on at least 3 polished cross-sections of the body. The cross sections can be coated with carbon of up to 5 nm to prevent charging. For each coated cross section, five 50×38 μm areas without porosity can be mapped using the map resolution of 800×600 and EBSP resolution of 160×120. Digital image analysis can be performed on the collected pattern quality map to determine the content of the amorphous phase.

In a further embodiment, the secondary phase may include one or more of secondary crystalline phases. For example, the secondary phase may include crystals that may contain one or more complex oxides. In a particular embodiment, the secondary crystalline phases may include crystals including spinel (MgAl₂O₄), hibonite ((Al, Ti, Mg)₁₂O₁₉), anorthite (CaAl₂Si₂O₈), gehlenite (Ca₂Al(SiAl)O₇), or any combination thereof.

In an embodiment, the body may include a particular content of a secondary crystalline phase including hibonite that may facilitate improved properties of the ceramic article. In an example, the secondary crystalline phase including hibonite may be at least 1 wt. % for a total weight of crystalline phases in the body, such as at least 1.5 wt. %, at least 2 wt. %, at least 2.5 wt. %, at least 3.0 wt. %, at least 3.5 wt. %, or at least 4 wt. % for the total weight of the crystalline phases of the body. In another example, the secondary crystalline phase including hibonite may be in a content of not greater than 7 wt. % for the total weight of the crystalline phases of the body, such as not greater than 6 wt. %, not greater than 5.5 wt. %, not greater than 5 wt. %, or not greater than 4.5 wt. % for the total weight of the crystalline phases of the body. Moreover, the body may include a content of the secondary crystalline phase including hibonite in a content including any of the minimum and maximum percentages noted herein. In another embodiment, the secondary phase may include a crystalline phase consisting essentially of hibonite.

In an embodiment, the body may include a secondary crystalline phase including spinel in a particular content that may facilitate improved properties of the ceramic article. In an example, the secondary crystalline phase including spinel may be in a content of at least 0.5 wt. % for the total weight of crystalline phases of the body, at least 1 wt. %, at least 1.5 wt. %, at least 2 wt. %, at least 2.5 wt. %, or at least 3 wt. % for the total weight of the crystalline phases of the body. Additionally or alternatively, the secondary crystalline phase including spinel may be in a content of not greater than 5 wt. % for the total weight of crystalline phases of the body, not greater than 4.5 wt. %, not greater than 4 wt. %, not greater than 3.5 wt. %, not greater than 3 wt. %, or not greater than 2.5 wt. % for the total weight of crystalline phases of the body. Moreover, the content of the secondary crystalline phase including spinel may include any of the minimum and maximum percentages noted herein. In another embodiment, the secondary phase may include a crystalline phase consisting essentially of spinel.

In an embodiment, the body may include a secondary crystalline phase including anorthite in a particular content that may facilitate improved properties of the ceramic article. In an example, the secondary crystalline phase comprising anorthite may be in a content of at least 3 wt. % for the total weight of crystalline phases, such as at least 3.5 wt. %, at least 4 wt. %, at least 4.5 wt. %, at least 5.0 wt. %, at least 5.5 wt. %, at least 6 wt. %, or at least 6.5 wt. % for the total weight of crystalline phases of the body. Additionally or aternatively, the secondary crystalline phase including anorthite may be in a content of not greater than 10 wt. % for the total weight of crystalline phases of the body, such as not greater than 9.5 wt. %, not greater than 8.5 wt. %, not greater than 8 wt. %, not greater than 7.5 wt. %, or not greater than 7 wt. % for the total weight of crystalline phases of the body. Moreover, the content of the secondary crystalline phase including anorthite may include any of the minimum and maximum percentages noted herein. In another embodiment, the secondary phase may include a crystalline phase consisting essentially of anorthite.

In an embodiment, the body may include a particular content of a secondary crystalline phase including gehlenite that may facilitate improved properties of the ceramic article. In an example, the secondary crystalline phase including gehlenite may be in a content of at lease 0.5 wt. % for the total weight of crystalline phases of the body, at least 1 wt. % at least 1.5 wt. %, at least 2 wt. %, at least 2.5 wt. %, or at least 3 wt. % for the total weight of the crystalline phases of the body. In another example, the secondary crystalline phase including gehlenite is in a content of not greater than 7 wt. % for the total weight of crystalline phases of the body, such as not greater than 6.5 wt. %, not greater than 5.5 wt. %, not greater than 5 wt. %, not greater than 4.5 wt. %, or not greater than 4 wt. % for the total weight of the crystalline phases of the body. Moreover, the content of the secondary crystalline phase including gehlenite may include any of the minimum and maximum percentages noted herein. In another embodiment, the secondary phase may include a crystalline phase consisting essentially of gehlenite.

In an embodiment, the crystalline phases in the body may include the primary phase and the secondary crystalline phases. In a further embodiment, the body may include a particular total content of crystalline phases, C_{TC}, that may facilitate improved properties of the ceramic article. In an example, the total content of crystalline phases, C_{TC}, may be not greater than 93.3 vol % for the volume of the body, such as not greater than 93 vol %, not greater than 92.5 vol %, not greater than 92 vol %, not greater than 91.5 vol %, not greater than 91 vol %, not greater than 90.5 vol %, not greater than 90 vol %, not greater than 89 vol %, not greater than 88 vol %, not greater than 87 vol %, not greater than 86 vol %, not greater than 85 vol %, not greater than 84 vol %, not greater than 83 vol %, or not greater than 82 vol % for the total volume of the body. In another example, the body may include a total content of crystalline phases, C_{TC}, of at least 78 vol % for the volume of the body, such as at least 79 vol %, at least 80 vol %, at least 81 vol %, at least 82 vol %, at least 83 vol %, at least 84 vol %, at least 85 vol %, at least 85.5 vol %, at least 86.5 vol %, at least 87 vol %, at least 88 vol %, at least 88.5 vol %, at least 89 vol %, at least 89.5 vol %, at least 90 vol %, at least 90.5 vol %, at least 91 vol %, at least 91.5 vol %, or at least 92 vol % for the volume of the body. Moreover, the total content of crystalline phases in the body may include any of the minimum and maximum percentages noted herein.

In an embodiment, the body may include a particular content of the primary phase for the total weight of the crystalline phases of the body, which may facilitate improved properties of the ceramic articles. In an example, the primary phase may be in a content of at least 80 wt. % for the total weight of crystalline phases of the body, at least 82 wt. %, at least 83 wt. %, at least 84 wt. %, at least 85 wt. %, or at least 86 wt. % for the total weight of the crystalline phase of the body. Alternatively or additionally, the primary phase may be in the content of not greater than 92 wt. % for the total weight of crystalline phases of the body, such as not greater than 90 wt. %, not greater than 89 wt. %, not greater than 88 wt. %, not greater than 87 wt. %, not greater than 86 wt. %, or not greater than 85 wt. % for the total weight of the crystalline phases of the body.

In an embodiment, the body may include a particular total content of the secondary phases that may facilitate improved properties of the ceramic articles, wherein the secondary phases may include the amorphous phase and secondary crystalline phases. In an example, the total content of the secondary phases may be at least 5 wt. % for the weight of the body, at least 7 wt. %, at least 9 wt. %, at least 10 wt. %, at least 11 wt. %, at least 12 wt. %, at least 13 wt. %, at least 14 wt. %, at least 15 wt. %, or at least 16 wt. % for the weight of the body. Alternatively or additionally, the total content of the secondary phases may be not greater than 35 wt. % for the weight of the body, such as not greater than 30 wt. %, not greater than 25 wt. %, not greater than 22 wt. %, not greater than 20 wt. %, not greater than 18 wt. %, not greater than 16 wt. %, not greater than 14 wt. %, not greater than 12 wt. %, not greater than 10 wt. %, not greater than 9 wt. %, not greater than 8 wt. %, not greater than 7 wt. %, not greater than 6 wt. %, or not greater than 5 wt. % for the weight of the body. Moreover, the total content of the secondary phases may be in a range including any of the minimum and maximum percentages noted herein.

In an embodiment, the body may include a particular total content of the secondary crystalline phases for the total weight of crystalline phases of the body, which may facilitate improved properties of the ceramic articles. In an example, the total content of secondary crystalline phases may be in a content of at least 8 wt. % for the total weight of the crystalline phases of the body, at least 8.5 wt. %, at least 9 wt. %, at least 9.4 wt. %, at least 9.8 wt. %, at least 10 wt. %, at least 12 wt. %, or at least 15 wt. % for the total weight of the crystalline phase of the body. Alternatively or additionally, the total content of the secondary crystalline phases may be not greater than 20 wt. % for the total weight of the crystalline phases of the body, such as not greater than 18 wt. %, not greater than 15 wt. %, not greater than 14 wt. %, or not greater than 12 wt. % for the total weight of the crystalline phases of the body. Moreover, the total content of the secondary crystalline phases may be in a range including any of the minimum and maximum percentages noted herein.

In a further embodiment, oxides may be present in certain contents in the body or one or more phases of the body. It is to be appreciated that the content of a simple oxide in the body or a phase can include contents of the simple oxide contained in all the forms that are present in the body or the phase. For example, the body or the secondary phase may include CaO in the simple oxide form and CaAl₂Si₂O₈ that may be expressed as CaO-Al₂O₃·2SiO₂ and thus considered in this disclosure containing CaO. The content of CaO in the body or the secondary phase may include contents of simple CaO and contents contained in CaAl₂Si₂O₈. The content of an oxide can be determined using ICP or using ICP and mass balance based on contents of other oxides, the content of primary phase, the contents of one or more secondary phases, or a combination thereof.

In an embodiment, the body may include a particular content of CaO for the weight of the body, C_{bCaO}, that may facilitate improved formation and properties of the ceramic articles. In an embodiment, the content of CaO, C_{bCaO}, may be greater than 2.5 wt. %, such as at least 2.7 wt. %, at least 2.8 wt. %, at least 3.0 wt. %, at least 3.2 wt. %, or at least 3.3 wt. % for the weight of the body. Alternatively or additionally, the content of CaO may be not greater than 9 wt. %, not greater than 8 wt. %, not greater than 7 wt. %, not greater than 6 wt. %, not greater than 5 wt. %, not greater than 4 wt. %, not greater than 3.5 wt. %, not greater than 3.3 wt. %, or not greater than 3.1 wt. % for the weight of the body. Moreover, the body may include a content of CaO in a range including any of the minimum and maximum percentages noted herein. The content of CaO can be determined using Inductively coupled Plasma (ICP) analysis.

In a further embodiment, the body may include a content of SiO₂, C_{bSiO2}, that may facilitate improved formation and properties of the ceramic articles. In an embodiment, C_{bSiO2} may be at least 2.3 wt. %, at least 2.5 wt. %, at least 2.7 wt. %, at least 2.8 wt. %, at least 3.0 wt. %, at least 3.2 wt. %, at least 3.4 wt. %, at least 3.5 wt. %, at least 3.7 wt. %, at least 3.9 wt. %, at least 4.1 wt. %, at least 4.3 wt. %, at least 4.5 wt. %, at least 4.7 wt. %, or at least 4.9 wt. % for the weight of the body. Alternatively or additionally, C_{bSiO2} may be less than 7 wt. %, not greater than 6.8 wt. %, not greater than 6.5 wt. %, not greater than 6.3 wt. %, not greater than 6.1 wt. %, not greater than 5.9 wt. %, not greater than 5.7 wt. %, not greater than 5.5 wt. %, not greater than 5.3 wt. %, not greater than 5.1 wt. %, not greater than 4.9 wt. %, not greater than 4.6 wt. %, or not greater than 4.4 wt. % for the weight of the body. Moreover, the body may include a content of SiO₂ in a range including any of the minimum and maximum percentages noted herein. The content of SiO₂ can be determined using Inductively coupled Plasma (ICP) analysis.

In a embodiment, the body may include a particular ratio, C_{bSi/Ca}, of C_{bSiO2} to C_{bCaO}, that may facilitate improved formation and properties of the ceramic articles. In an embodiment, the ratio, C_{bSi/Ca}, of C_{bSiO2} to C_{bCaO} may be not greater than 26, not greater than 23, not greater than 20, not greater than 17, not greater than 14, not greater than 11, not greater than 8.5, not greater than 7.5, not greater than 6.5, not greater than 5.3, not greater than 4.0, not greater than 3.5, not greater than 2.5, not greater than 2, or not greater than 1.5. Alternatively or additionally, the ratio C_{bSi/Ca} may be at least 0.3, at least 0.5, at least 0.7, at least 0.9, at least 1.1, at least 1.3, or at least 1.4. Moreover, the body may include the ratio C_{bSi/Ca} in a range including any of the minimum and maximum values noted herein.

In a further embodiment, the body may include a content of MgO, C_{bMgO}, that may facilitate improved formation and properties of the ceramic articles. In an embodiment, the content of MgO may be at least 0.4 wt. %, at least 0.5 wt. %, at least 0.6 wt. %, at least 0.7 wt. %, at least 0.8 wt. %, or at least 0.9 wt. % for the weight of the body. Alternatively or additionally, the content of MgO may be less than 1.9 wt. %, not greater than 1.5 wt. %, not greater than 1.3 wt. %, not greater than 1.1 wt. %, not greater than 0.9 wt. %, not greater than 0.8 wt. %, or not greater than 0.7 wt. % for the weight of the body. Moreover, the body may include the content of MgO in a range including any of the minimum and maximum percentages noted herein. The content of MgO can be determined using Inductively coupled Plasma (ICP) analysis.

In a embodiment, the body may include a particular content ratio of C_{bCaO} to C_{bMgo} that may facilitate improved formation and properties of the ceramic articles. In a further embodiment, the ratio of C_{bCaO} to C_{bMgO}, C_{bCa/Mg}, may be greater than 1, such as at least 1.2, at least 1.5, at least 1.8, at least 2.1, at least 2.3, at least 2.5, at least 2.8, at least 3.0, at least 3.3, at least 3.5, at least 3.8, at least 4.0, or at least 4.2. Alternatively or additionally, the ratio C_{bCa/Mg} may be not greater than 10, not greater than 8.5, not greater than 7.5, not greater than 6.5, not greater than 5.5, not greater than 4.5, or not greater than 4. Moreover, the body may include the ratio C_{bCa/Mg} in a range including any of the minimum and maximum values noted herein.

In a embodiment, the body may include a content of BaO of not greater than 0.9 wt. %, such as not greater than 0.8 wt. %, not greater than 0.7 wt. %, not greater than 0.5 wt. %, not greater than 0.3 wt. %, not greater than 0.2 wt. %, not greater than 0.1 wt. %, or not greater than 0.05 wt. % for the total weight of o the body. Additionally or alternatively, the body may include a content of BaO of at least 50 ppm for the weight of the body, such as at least 80 ppm, at least 100 ppm, at least 150 ppm, or at least 200 ppm for the weight of the body. Moreover, the body may include a content of BaO in a range including any of the minimum and maximum values noted herein. In a particular example, the body may be essentially free of BaO. In another particular example, the body may be essentially free of an oxide including BaO. The content of BaO can be determined using Inductively coupled Plasma (ICP) analysis.

In a embodiment, the body may include a total content of alkaline earth metal oxides that may facilities improved formation and/or performance of the ceramic article. In an example, the body may include at least 3.0 wt. %, at least 3.2 wt. %, at least 3.4 wt. %, at least 3.5 wt. %, at least 3.7 wt. %, at least 3.9 wt. %, at least 4.1 wt. %, or at least 4.2 wt. % for the weight of the body. In another example, the body may include a total content of alkaline earth metal oxide of not greater than 11.5 wt. %, not greater than 10.5 wt. %, not greater than 9.5 wt. %, not greater than 8.5 wt. %, not greater than 7.5 wt. %, not greater than 6.5 wt. %, not greater than 5.5 wt. %, not greater than 4.5 wt. %, or not greater than 3.5 wt. % for the weight of the body. Moreover, the body may include a total content of alkaline earth metal oxides in a range including any of the minimum and maximum percentages noted herein. The contents of alkaline earth metal oxides can be determined using Inductively coupled Plasma (ICP) analysis and used to calculate the total content of alkaline earth metal oxides.

In an embodiment, the body may include a total content of alkali metal oxides of not greater than 6.5 wt. % for the weight of the body, not greater than 5.5 wt. %, not greater than 4.5 wt. %, not greater than 4 wt. %, not greater than 3.5 wt. %, not greater than 3.1 wt. %, not greater than 2.5 wt. %, or not greater than 2.1 wt. % for the weight of the body. Alternatively or additionally, the body may include the total content of alkali metal oxides of at least 0.3 wt. % for the weight of the body, at least 0.5 wt. %, at least 0.7 wt. %, at least 0.8 wt. %, or at least 0.9 wt. %, or at least 1.1 wt. % for the weight of the body. Moreover, the body may include a total content of alkali metal oxides in a range including any of the minimum and maximum percentages noted herein. In a particular embodiment, the body may be essentially free of alkali metal oxides. The contents of alkali metal oxides can be determined using Inductively coupled Plasma (ICP) analysis and used to calculate the total content of alkali metal oxides.

In an embodiment, the secondary phase of the body may include a particular content of CaO, C_{P2CaO}, for the total weight of the secondary phase that may facilitate improved formation or performance of the ceramic article. The total weight of the secondary phase is intended to include the weight of the amorphous phase and the total weight of the secondary crystalline phases. In an example, C_{P2CaO} may be at least 6 wt. % for the total weight of the secondary phase, at least 8 wt. %, at least 10 wt. %, at least 13 wt. %, at least 15 wt. %, at least 18 wt. %, at least 20 wt. %, at least 22 wt. %, at least 25 wt. %, at least 28 wt. %, at least 20 wt. %, at least 32 wt. %, or at least 34 wt. % for the total weight of the secondary phase. In another example, C_{P2CaO} may be not greater than 41 wt. %, not greater than 39 wt. %, not greater than 3 wt. %, not greater than 34 wt. %, not greater than 32 wt. %, not greater than 30 wt. %, not greater than 27 wt. %, not greater than 25 wt. %, not greater than 23 wt. %, not greater than 20 wt. %, not greater than 18 wt. %, or not greater than 15 wt. % for the total weight of the secondary phase. Moreover, the secondary phase may include content of CaO, C_{P2CaO}, in a range including any of the minimum and maximum percentages noted herein. In an embodiment, the secondary phase may include one or more simple oxide and one or more oxides that may be expressed as containing simple oxides.

In an embodiment, the secondary phase may include a particular content of MgO, C_{P2MgO}, in the secondary phase that may facilitate improved formation or performance of the ceramic article. In an example, C_{P2MgO} may be greater than 5 wt. %, at least 6 wt. %, at least 7 wt. %, at least 8 wt. %, at least 9 wt. %, or at least 10 wt. % for the total weight of the secondary phase. In a further example, C_{P2MgO} may be less than 15 wt. % for the total weight of the secondary phase, not greater than 14.5 wt. %, not greater than 14 wt. %, not greater than 13 wt. %, not greater than 12 wt. %, not greater than 11 wt. %, or not greater than 10 wt. % for the total weight of the secondary phase. Moreover, the secondary phase may include a content of MgO, C_{P2MgO}, in a range including any of the minimum and maximum percentages noted herein.

In an embodiment, the secondary phase may include a particular content of SiO₂, C_{P2SiO2}, in the secondary phase that may facilitate improved formation or performance of the ceramic article. In an example, C_{P2SiO2} may be at least 35 wt. %, at least 38 wt. %, at least 40 wt. %, at least 42 wt. %, at least 45 wt. %, at least 47 wt. %, at least 49 wt. %, at least 60 wt. %, or at least 62 wt. % for the total weight of the secondary phase. In another example, C_{P2SiO2} may be not greater than 70 wt. %, not greater than 69 wt. %, not greater than 67 wt. %, not greater than 64 wt. %, not greater than 62 wt. %, not greater than 60 wt. %, not greater 57 wt. %, not greater than 54 wt. %, not greater than 51 wt. %, not greater than 48 wt. %, not greater than 45 wt. %, or not greater than 44 wt. % for the total weight of the secondary phase. Moreover, the secondary phase may include a content of SiO₂, C_{P2SiO2}, in a range including any of the minimum and maximum percentages noted herein.

In an embodiment, the secondary phase may include a particular content of alumina (Al₂O₃), C_{P2Al2O3}, that may facilitate improved formation or performance of the ceramic article.

In an example, C_{P2Al2O3} may be at least 5 wt. %, at least 7 wt. %, at least 9 wt. %, at least 11 wt. %, at least 13 wt. %, or at least 15 wt. % for the total weight of the secondary phase. In another example, C_{P2Al2O3} may be not greater than 32 wt. % for the total weight of the secondary phase, such as not greater than 30 wt. %, not greater than 28 wt. %, not greater than 26 wt. %, not greater than 23 wt. %, not greater than 20 wt. %, not greater than 18 wt. %, not greater than 16 wt. %, not greater than 15 wt. %, or not greater than 13 wt. % for the total weight of the secondary phase. Moreover, the secondary phase may include a content of Al₂O₃, C_{P2Al2O3}, in a range including any of the minimum and maximum percentages noted herein.

In an embodiment, the secondary phase may include a particular ratio, C_{P2Ca/Mg}, of C_{P2CaO} to C_{P2MgO} that may facilitate improved formation or performance of the ceramic article, wherein C_{P2CaO} is the content of CaO and C_{P2MgO} is the content of MgO in the secondary phase. In an example, C_{P2Ca/Mg} may be greater than 1, at least 1.2, at least 1.5, at least 1.7, at least 1.9, at least 2.1, at least 3.3, at least 2.5, at least 2.7, at least 3, at least 3.3, at least 3.5, at least 3.7, at least 3.9, at least 4.0, or at least 4.1. In another example, C_{P2Ca/Mg} may be not greater than 6.5, not greater than 6.3, not greater than 6.1, not greater than 5.9, not greater than 5.7, not greater than 5.5, not greater than 5.3, not greater 5.1, not greater than 4.8, not greater than 4.6, not greater than 4.3, or not greater than 4.1. Moreover, the secondary phase may include a content ratio C_{P2Ca/Mg} in a range including any of the minimum and maximum percentages noted herein.

In an embodiment, the secondary phase may include a particular ratio, C_{P2Si/Mg}, of C_{P2SiO2} to C_{P2MgO} that may facilitate improved formation or performance of the ceramic article, wherein C_{P2SiO2} is the content of SiO₂ and C_{P2MgO} is the content of MgO in the secondary phase. In an example, C_{P2Si/Mg} may be greater than 3.6, greater than 5.5, at least 5.6, at least 5.7, at least 5.8, at least 5.9, or at least 6. In another example, C_{P2Si/Mg} may be less than 14, less than 11, not greater than 10, not greater than 9, not greater than 8, not greater than 7, or not greater than 6. In a further example, C_{P2Si/Mg} may be in a range including any of the minimum and maximum percentages noted herein.

In an embodiment, the secondary phase may include a particular ratio, C_{P2Si/Ca}, of C_{P2SiO2} to C_{P2CaO} that may facilitate improved formation or performance of the ceramic article, wherein C_{P2SiO2} is the content of SiO₂ and C_{P2CaO} is the content of CaO in the secondary phase. In an example, C_{P2Si/Ca} may be at least 1.2, at least 1.4, at least 1.6, at least 1.8, at least 2.1, at least 2.4, at least 2.6, at least 2.8, at least 3.2, at least 3.5, at least 3.8, at least 4.0, or at least 4.2. In another example, C_{P2Si/CaMg} may be not greater than 10, not greater than 9, not greater than 8, not greater than 7, not greater than 6, not greater than 5, or not greater than 4. In a further example, C_{P2Si/Ca} may be in a range including any of the minimum and maximum percentages noted herein.

In an embodiment, the secondary phase may include a particular ratio, C_{P2Al/Ca}, of C_{P2Al2O3} to C_{P2CaO} that may facilitate improved formation or performance of the ceramic article, wherein C_{P2Al2O3} is the content of alumina (Al₂O₃) in the secondary phase. In an example, C_{P2Al/Ca} may be at least 0.3, at least 0.4, at least 0.5, at least 0.6, at least 0.7, at least 0.8, at least 0.9, at least 1, at least 1.1, or at least 1.2. Additionally or alternatively, C_{P2Al/Ca} may be not greater than 1.7, not greater than 1.5, not greater than 1.3, not greater than 1.2, not greater than 1.1, not greater than 1, not greater than 0.9, not greater than 0.8, not greater than 0.7, not greater than 0.6, or not greater than 0.5. In a further example, C_{P2Al/Ca} may be in a range including any of the minimum and maximum percentages noted herein.

In an embodiment, the secondary phase may include a particular ratio, C_{P2Al/Mg}, of the content of alumina (Al₂O₃), C_{P2Al2O3}, to the content of MgO, C_{P2MgO}, that may facilitate improved formation or performance of the ceramic article. In an example, C_{P2Al/Mg} may be at least 1, at least 1.1, at least 1.2, at least 1.3, at least 1.4, at least 1.5, at least 1.6, at least 1.7, at least 1.8, or at least 1.9. Additionally or alternatively, C_{P2Al/Mg} may be not greater than 2.6, not greater than 2.5, not greater than 2.4, not greater than 2.2, not greater than 2.1, not greater than 2, not greater than 1.9, not greater than 1.8, not greater than 1.7, not greater than 1.6, not greater than 1.5, or not greater than 1.4. In a further example, C_{P2Al/Mg} may be in a range including any of the minimum and maximum percentages noted herein.

In an embodiment, the secondary phase may include a particular ratio, C_{P2Si/Al}, of C_{P2SiO2} to C_{P2Al2O3} that may facilitate improved formation and/or performance of the ceramic article, wherein C_{P2SiO2} is the content of SiO₂ and C_{P2Al2O3} is the content of alumina (Al₂O₃). In an example, C_{P2Si/Al} may be at least 2, at least 2.4, at least 2.6, at least 2.8, at least 2.9, at least 3, at least 3.1, at least 3.2, at least 3.3, at least 3.4, at least 3.5, at least 3.6, at least 3.8, at least 4.0, or at least 4.1. Additionally or alternatively, C_{P2Si/Al} may be not greater than 5, not greater than 4.8, not greater than 4.6, not greater than 4.4, not greater than 4.2, not greater than 4.1, not greater than 4, not greater than 3.8, not greater than 3.7, not greater than 3.6, not greater than 3.5, not greater than 3.4, not greater than 3.3, not greater than 3.2, not greater than 3.1, or not greater than 3. In a further example, C_{P2Si/Al} may be in a range including any of the minimum and maximum percentages noted herein.

In an embodiment, the body may include a particular total content of secondary crystalline phases that may facilitate improved performance of the ceramic article. In an example, the body may include a total content of secondary crystalline phases of at least 5 wt. % for the weight of the body, such as at least 6 wt. %, at least 7 wt. %, at least 8 wt. %, at least 9 wt. %, at least 10 wt. %, at least 11 wt. %, at least 12 wt. %, at least 13 wt. %, at least 14 wt. %, at least 15 wt. %, or at least 16 wt. % for the weight of the body. In another example, the total content of secondary crystalline phases may be not greater than 25 wt. %, not greater than 22 wt. %, not greater than 20 wt. %, not greater than 19 wt. %, not greater than 18 wt. %, not greater than 17 wt. %, not greater than 16.5 wt. % not greater than 16 wt. %, not greater than 15.5 wt. %, not greater than 15 wt. %, not greater than 14.5 wt. %, not greater than 14 wt. %, not greater than 13.5 wt. %, not greater than 13 wt. %, not greater than 12.5 wt. %, or not greater than 12 wt. % for the weight of the body. In a further example, the total content of secondary crystalline phases may be in a range including any of the minimum and maximum percentages noted herein.

In an embodiment, the body may include a particular porosity that may facilitate improved performance of the ceramic article. In an example, the body may include a porosity of not greater than 15 vol % for the volume of the body, such as not greater than 13 vol %, not greater than 11 vol %, not greater than 10 vol %, not greater than 9 vol %, not greater than 8 vol %, not greater than 7 vol %, not greater than 6 vol %, not greater than 5 vol %, not greater than 4 vol %, not greater than 3 vol %, not greater than 2 vol %, not greater than 1 vol %, or not greater than 0.5 vol % for the volume of the body. In another example, the body may include at least 0.01 vol % of porosity, at least 0.1 vol %, at least 0.2 vol %, at least 0.3 vol %, at least 0.4 vol %, or at least 0.5 vol % of porosity for the volume of the body. In a further example, the body may include a porosity in a range including any of the minimum and maximum percentages noted herein.

In an embodiment, the body may include a particular density that may facilitate improved performance of the ceramic article. In an example, the body may include a density of at least 3.51 g/cm³, at least 3.52 g/cm³, at least 3.53 g/cm³, at least 3.55 g/cm³, at least 3.56 g/cm³, at least 3.57 g/cm³, at least 3.58 g/cm³, at least 3.59 g/cm³, at least 3.60 g/cm³, at least 3.61 g/cm³, at least 3.62 g/cm³, at least 3.63 g/cm³, or at least 3.64 g/cm³. In another example, the body may include a density of not greater than 3.67 g/cm³, not greater than 3.66 g/cm³, not greater than 3.65 g/cm³, not greater than 3.64 g/cm³, not greater than 3.63 g/cm³, not greater than 3.62 g/cm³, not greater than 3.61 g/cm³, not greater than 3.60 g/cm³, not greater than 3.59 g/cm³, not greater than 3.58 g/cm³, not greater than 3.57 g/cm³, not greater than 3.56 g/cm³, not greater than 3.55 g/cm³, not greater than 3.54 g/cm³, not greater than 3.53 g/cm³, or not greater than 3.52 g/cm³. Moreover, the body may have a density in a range including any of the minimum and maximum values noted herein.

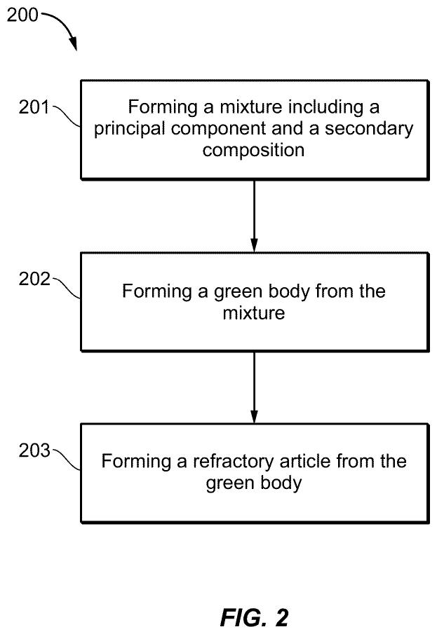

FIG. 2 includes a flow chart including an illustration of a process 200 according to an embodiment. The process 200 may start at block 201 to form a mixture including materials including oxides. In an embodiment, the mixture may include a number of starting materials including ceramic precursor materials, one or more oxides, or any combination thereof.

In an embodiment, the mixture may include a principal component including alumina, wherein the principal component may be at least 75 wt. % for the total weight of the mixture, such as 78 wt. %, at least 80 wt. %, at least 83 wt. %, at least 85 wt. %, or at least 87 wt. % for the total weight of the mixture. Alternatively or additionally, the mixture may include not greater than 95 wt. % of the principal component, such as not greater than 92 wt. %, not greater than 90 wt. %, not greater than 88 wt. %, not greater than 87 wt. %, or not greater than 85 wt. % for the total weight of the mixture. Moreover, the principal component may be in a range including any of the minimum and maximum percentages noted herein.

In a further embodiment, the mixture may include a secondary composition including one or more oxides, ceramic precursors, or any combination thereof that may facilitate formation of a liquid phase at a higher temperature. In a particular embodiment, the secondary composition may include a particular combination of ceramic precursors that may facilitate formation of the body including particular contents of oxides noted in embodiments herein. In an example, the ceramic precursors may include silica, clay, talc, dolomite, wollastonite, CaCO₃, or the like, or any combination thereof. In another embodiment, the secondary composition may include one or more of an alkaline earth metal oxide, an alkali metal oxide, Al₂O₃, SiO₂, TiO₂, Fe₂O₃, ZrO₂, or any combination thereof. In a particular embodiment, the secondary composition may include oxides including CaO, MgO, Al₂O₃, and SiO₂. As will be appreciated, the mixture may include unavoidable impurities that may be contained in the secondary composition, or the principal component may include or another component of the mixture. Exemplary impurity may include oxides, such as one or more of alkali metal oxide, BaO, SrO, TiO₂, Fe₂O₃, ZrO₂, MnO₂, or any combination thereof. The total content of impurities may be not greater than 1 wt. % or not greater than 0.5 wt. % for the total weight of the mixture.

In a further embodiment, the mixture may include at least 7 wt. % of the secondary composition for a total weight of the mixture, such as at least 8 wt. %, at least 10 wt. %, at least 12 wt. %, at least 13 wt. %, or at least 15 wt. % for the total weight of the mixture. Alternatively or additionally, the mixture may include not greater than 22 wt. % of the secondary composition for the total weight of the mixture, such as not greater than 20 wt. %, not greater than 18 wt. %, not greater than 15 wt. %, or not greater than 13 wt. % of the secondary composition for the total weight of the mixture. Moreover, the secondary composition may be in a range including any of the minimum and maximum percentages noted herein.

In a further embodiment, the secondary composition may include a particular content of CaO that may facilitate improved formation and/or performance of the ceramic article. For example, the content of CaO may be at least 15 wt. % for the total weight of the secondary composition, at least 17 wt. %, or at least 19 wt. % for the total weight of the secondary composition. In another example, the content of CaO may be not greater than 32 wt. %, not greater than 30 wt. %, not greater than 28 wt. %, or not greater than 25 wt. % for the total weight of the secondary composition. Moreover, the content of CaO may be in a range including any of the minimum and maximum percentages noted herein.

In a further embodiment, the secondary composition may include a particular content of MgO that may facilitate improved formation and/or performance of the ceramic article. For example, the content of MgO may be at least 3 wt. % for the total weight of the secondary composition, at least 5 wt. %, at least 7 wt. %, or at least 9 wt. % for the total weight of the secondary composition. In another example, the content of MgO may be not greater than 12 wt. %, not greater than 10 wt. %, not greater than 8 wt. %, or not greater than 7 wt. % for the total weight of the secondary composition. Moreover, the content of MgO may be in a range including any of the minimum and maximum percentages noted herein. In a particular embodiment, the secondary composition may include a higher content of CaO than MgO.

In a further embodiment, the secondary composition may include a particular content of SiO₂ that may facilitate improved formation and/or performance of the ceramic article. For example, the content of SiO₂ may be at least 29 wt. % for the total weight of the secondary composition, at least 32 wt. %, at least 34 wt. %, at least 36 wt. %, at least 38 wt. %, at least 40 wt. %, or at least 42 wt. % for the total weight of the secondary composition. In another example, the content of SiO₂ may be not greater than 52 wt. %, not greater than 50 wt. %, not greater than 48 wt. %, not greater than 46 wt. %, or not greater than 43 wt. % for the total weight of the secondary composition. Moreover, the content of SiO₂ may be in a range including any of the minimum and maximum percentages noted herein. In a particular embodiment, the secondary composition may include a higher content of SiO₂ than CaO.

In a further embodiment, the secondary composition may include a particular content of Al₂O₃ that may facilitate improved formation and/or performance of the ceramic article. For example, the content of Al₂O₃ may be at least 9 wt. % for the total weight of the secondary composition, at least 11 wt. %, at least 13 wt. %, or at least 15 wt. % for the total weight of the secondary composition. In another example, the content of Al₂O₃ may be not greater than 24 wt. %, not greater than 22 wt. %, not greater than 20 wt. %, or not greater than 18 wt. % for the total weight of the secondary composition. Moreover, the content of Al₂O₃ may be in a range including any of the minimum and maximum percentages noted herein.

The mixture may further include an additional material including a binder, an anti-foaming agent, a solvent, a dispersant, a thickener, a deflocculant, another suitable ingredient, or any combination thereof. In an embodiment, the additional material can include non-metallic compounds. In another embodiment, the additional material can include an organic compound, water, or the like. When the additional material includes a binder, the binder can include a resin, a polymeric compound, or another suitable organic compound that can be used a binder.

The process 200 may include treating the mixture including ball milling, spray drying, granulation, or any combination thereof to facilitate formation of a homogenous dry mixture.

The process 200 may continue at block 202 to form a green body from the mixture. Forming the green body may include casting, molding, pressing, extruding, and the like to give the initial mixture shape. In an embodiment, the green body may include a length, a width, and/or a thickness. In a particular example, the green body may include a length≥width≥thickness. It is to be appreciated that the green body may have any suitable shape or dimension as desired by applications.

The process 200 may continue at block 203 to form a ceramic article from the green body. In an embodiment, the process 200 can include firing the green body to form the finally formed body of the ceramic article. The green body can be heated in an oven, heater, furnace, or the like. The heating process can include an initial heating where moisture, a solvent, or another volatile component is evaporated, organic material is vaporized, or any combination thereof. The initial heating can be conducted at a temperature in a range of approximately 100° C. to approximately 700° C. for a time period in a range of approximately 8 hours to approximately 200 hours. Following the initial heating, the sintering can be performed at a temperature in a range of approximately 1300° C. to 1700° C. for a time period in a range of approximately 10 hours to approximately 100 hours to form the finally formed body. In an embodiment, forming the ceramic article may include a particular cooling process that may facilitate improved formation and/or performance of the ceramic article. In an embodiment, cooling may be performed at a rate of at least 0.5° C./min and not greater than 20° C./min. In a particular embodiment, the process 200 may include a particular cooling rate between the sintering temperature and the solidification temperature of the liquid phase that may facilitate improved formation and properties of the ceramic article. In a particular example, the process may include a cooling rate from 1700° C. to 1100° C. of at least 7° C./min, at least 8° C./min, at least 9° C./min, at least 10° C./min, at least 11° C./min, or at least 12° C./min. Alternatively or additionally, cooling rate from 1700° C. to 1100° C. may be not greater than 20° C./min, not greater than 19° C./min, not greater than 18° C./min, not greater than 17° C./min, not greater than 16° C./min, not greater than 15° C./min, or not greater than 14° C./min. Moreover, the cooling rate from 1700° C. to 1100° C. may be in a range including any of the minimum and maximum values noted herein. In another embodiment, the process 200 may include cooling without heat from the liquid phase solidification temperature to room temperature (i.e., 20-25° C.). For example, furnace power may be turned off for the furnace and sintered article to cool at nature rates (also referred to as “furnace cool” in this disclosure).

After cooling the body of a ceramic article may be formed. In exemplary applications, the body may be further treated to form the ceramic article. Treatment may include surface finishing, shaping, polishing, machining, or the like, or any combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A ceramic article, comprising a body comprising:
at least 83 wt. % of alumina (Al₂O₃) for a weight of the body;
a content of CaO, C_{bCaO}, for the weight of the body; and
a content of MgO, C_{bMgO}, for the weight of the body, wherein a ratio, C_{bCa/Mg}, of C_{bCaO} to C_{bMgO}, is greater than 1,
wherein the body comprises an amorphous phase of at least 6.7 vol % for a volume of the body.

Embodiment 2. A ceramic article, comprising a body comprising:
at least 83 wt. % of alumina (Al₂O₃) for a weight of the body; and
a content of CaO, C_{bCaO}, of greater than 2.5 wt. % for the weight of the body;
wherein the body comprises an amorphous phase of at least 6.7 vol % for a volume of the body.

Embodiment 3. A ceramic article, comprising a body comprising:
at least 83 wt. % of alumina (Al₂O₃) for a weight of the body, wherein grains of alumina have an average grain size of greater than 2 microns, a maximum grain size greater than 6 microns, or a combination thereof; and
a content of CaO, a content of MgO, or a combination thereof;
wherein the body comprises an amorphous phase of at least 6.7 vol % for a volume of the body.

Embodiment 4. The ceramic article of any one of embodiments 1 to 3, wherein the body comprises at least 85 wt. % of alumina, at least 87 wt. %, or at least 90 wt. % for the weight of the body; and/or less than 94 wt. % of alumina, not greater than 93 wt. %, not greater than 92 wt. %, not greater than 91 wt. %, or not greater than 90 wt. % for the weight of the body.

Embodiment 5. The ceramic article of any one of embodiments 1 to 4, wherein the body comprises a content of MgO, C_{bMgO}, for the weight of the body, wherein a ratio of C_{bCaO} to C_{bMgO}, C_{bCa/Mg}, is greater than 1, at least 1.2, at least 1.5, at least 1.8, at least 2.1, at least 2.3, at least 2.5, at least 2.8, at least 3.0, at least 3.3, at least 3.5, at least 3.8, at least 4.0, or at least 4.2; wherein the ratio C_{bCa/Mg} is not greater than 10, not greater than 8.5, not greater than 7.5, not greater than 6.5, not greater than 5.5, not greater than 4.5, or not greater than 4.

Embodiment 6. The ceramic article of any one of embodiments 1 to 5, wherein the content of CaO is greater than 2.5 wt. %, at least 2.7 wt. %, at least 2.8 wt. %, at least 3.0 wt. %, at least 3.2 wt. %, or at least 3.3 wt. % for the weight of the body; and/or wherein the content of CaO is not greater than 9 wt. %, not greater than 8 wt. %, not greater than 7 wt. %, not greater than 6 wt. %, not greater than 5 wt. %, not greater than 4 wt. %, not greater than 3.5 wt. %, not greater than 3.3 wt. %, or not greater than 3.1 wt. % for the weight of the body.

Embodiment 7. The ceramic article of any one of embodiments 1 to 6, wherein the content of MgO is at least 0.4 wt. %, at least 0.5 wt. %, at least 0.6 wt. %, at least 0.7 wt. %, at least 0.8 wt. %, or at least 0.9 wt. % for the weight of the body; and/or wherein the content of MgO is less than 1.9 wt. %, not greater than 1.5 wt. %, not greater than 1.3 wt. %, not greater than 1.1 wt. %, not greater than 0.9 wt. %, not greater than 0.8 wt. %, or not greater than 0.7 wt. % for the weight of the body.

Embodiment 8. The ceramic article of any one of embodiments 1 to 4, wherein the body comprises not greater than 0.9 wt. % of BaO, not greater than 0.8 wt. %, not greater than 0.7 wt. %, not greater than 0.5 wt. %, not greater than 0.3 wt. %, not greater than 0.2 wt. %, not greater than 0.1 wt. %, or not greater than 0.05 wt. % of BaO for the weight of the body; and/or at least 50 ppm, at least 80 ppm, at least 100 ppm, at least 150 ppm, or at least 200 ppm of BaO for the weight of the body.

Embodiment 9. The ceramic article of any one of embodiments 1 to 8, wherein the body is essentially free of BaO.

Embodiment 10. The ceramic article of any one of embodiments 1 to 9, wherein the body comprises a total content of alkaline earth metal oxides of at least 3.0 wt. %, at least 3.2 wt. %, at least 3.4 wt. %, at least 3.5 wt. %, at least 3.7 wt. %, at least 3.9 wt. %, at least 4.1 wt. %, or at least 4.2 wt. % for the weight of the body; and/or wherein the body comprises a total content of alkaline earth metal oxide of not greater than 11.5 wt. %, not greater than 10.5 wt. %, not greater than 9.5 wt. %, not greater than 8.5 wt. %, not greater than 7.5 wt. %, not greater than 6.5 wt. %, not greater than 5.5 wt. %, not greater than 4.5 wt. %, or not greater than 3.5 wt. % for the weight of the body.

Embodiment 11. The ceramic article of any one of embodiments 1 to 10, wherein the body is essentially free of B₂O₃.

Embodiment 12. The ceramic article of any one of embodiments 1 to 11, wherein the body comprises a content of SiO₂, C_{bSiO2}, for the weight of the body, wherein C_{bSiO2} is at least 2.3 wt. %, at least 2.5 wt. %, at least 2.7 wt. %, at least 2.8 wt. %, at least 3.0 wt. %, at least 3.2 wt. %, at least 3.4 wt. %, at least 3.5 wt. %, at least 3.7 wt. %, at least 3.9 wt. %, at least 4.1 wt. %, at least 4.3 wt. %, at least 4.5 wt. %, at least 4.7 wt. %, or at least 4.9 wt. % for the weight of the body; and/or wherein C_{bSiO2} is less than 7 wt. %, not greater than 6.8 wt. %, not greater than 6.5 wt. %, not greater than 6.3 wt. %, not greater than 6.1 wt. %, not greater than 5.9 wt. %, not greater than 5.7 wt. %, not greater than 5.5 wt. %, not greater than 5.3 wt. %, not greater than 5.1 wt. %, not greater than 4.9 wt. %, not greater than 4.6 wt. %, or not greater than 4.4 wt. % for the weight of the body.

Embodiment 13. The ceramic article of any one of embodiments 1 to 12, wherein a ratio, C_{bSi/Ca}, of C_{bSiO2} to C_{bCaO} is not greater than 26, not greater than 23, not greater than 20, not greater than 17, not greater than 14, not greater than 11, not greater than 8.5, not greater than 7.5, not greater than 6.5, not greater than 5.3, not greater than 4.0, not greater than 3.5, not greater than 2.5, not greater than 2, or not greater than 1.5, wherein C_{bSiO2} is a content of SiO₂ relative to the weight of the body; and/or wherein the ratio C_{bSi/Ca} is at least 0.3, at least 0.5, at least 0.7, at least 0.9, at least 1.1, at least 1.3, or at least 1.4.

Embodiment 14. The ceramic article of any one of embodiments 1 to 13, wherein the body comprises a total content of one or more alkali metal oxides of not greater than 6.5 wt. % for the weight of the body, not greater than 5.5 wt. %, not greater than 4.5 wt. %, not greater than 4 wt. %, not greater than 3.5 wt. %, not greater than 3.1 wt. %, not greater than 2.5 wt. %, or not greater than 2.1 wt. % for the weight of the body; and/or wherein the total content of one or more alkali metal oxides is at least 0.3 wt. % for the weight of the body, at least 0.5 wt. %, at least 0.7 wt. %, at least 0.8 wt. %, or at least 0.9 wt. %, or at least 1.1 wt. % for the weight of the body.

Embodiment 15. The ceramic article of any one of embodiments 1 to 14, wherein the body comprises K₂O, Na₂O, TiO₂, ZrO₂, Fe₂O₃, or any combination thereof.

Embodiment 16. The ceramic article of any one of embodiments 1 to 15, wherein the body is essentially free of one or more of K₂O, Na₂O, TiO₂, ZrO₂, Li₂O, and Fe₂O₃.

Embodiment 17. The ceramic article of any one of embodiments 1 to 14, wherein the body comprises a primary phase comprising crystalline alumina (Al₂O₃), wherein the primary phase is at least 70 wt. % for the weight of the body, at least 73 wt. %, at least 75 wt. %, at least 77 wt. %, at least 80 wt. %, at least 82 wt. %, at least 84 wt. %, at least 86 wt. %, at least 88 wt. %, or at least 90 wt. % for the weight of the body; and/or wherein the primary phase is not greater than 93 wt. %, not greater than 92 wt. %, not greater than 90 wt. %, not greater than 88 wt. %, not greater than 85 wt. %, not greater than 83 wt. %, not greater than 81 wt. %, not greater than 78 wt. %, or not greater than 75 wt. % for the weight of the body; and/or wherein the primary phase consists essentially of crystalline alumina; and/or wherein the primary phase consists essentially of corundum.

Embodiment 18. The ceramic article of any one of embodiments 1 to 15, wherein the body comprises a secondary phase comprising an oxide comprising an alkaline earth metal oxide, an alkali metal oxide, Al₂O₃, SiO₂, TiO₂, Fe₂O₃, ZrO₂, or any combination thereof.

Embodiment 19. The ceramic article of embodiment 18, wherein the secondary phase comprises the amorphous phase.

Embodiment 20. The ceramic article of embodiment 18 or 19, wherein the secondary phase comprises one or more secondary crystalline phases of spinel (MgAl₂O₄), hibonite ((Al, Ti, Mg)₁₂O₁₉), anorthite (CaAl₂Si₂O₈), and gehlenite (Ca₂Al(SiAl)O₇).

Embodiment 21. The ceramic article of embodiment 19 or 20, wherein the secondary phase comprises the amorphous phase and one or more secondary crystalline phases, and wherein the secondary phase comprises a content of MgO, C_{P2MgO}, for a total weight of the secondary phase, wherein C_{P2MgO} is greater than 5 wt. %, at least 6 wt. %, at least 7 wt. %, at least 8 wt. %, at least 9 wt. %, or at least 10 wt. % for the total weight of the secondary phase; and/or wherein C_{P2MgO} is less than 15 wt. % for the total weight of the secondary phase, not greater than 14.5 wt. %, not greater than 14 wt. %, not greater than 13 wt. %, not greater than 12 wt. %, not greater than 11 wt. %, or not greater than 10 wt. % for the total weight of the secondary phase.

Embodiment 22. The ceramic article of any one of embodiments 18 to 21, wherein the secondary phase comprises the amorphous phase and one or more secondary crystalline phases, and wherein the secondary phase comprises a content of CaO, C_{P2CaO}, for the total weight of the secondary phase, wherein C_{P2CaO} is at least 6 wt. %, at least 8 wt. %, at least 10 wt. %, at least 13 wt. %, at least 15 wt. %, at least 18 wt. %, at least 20 wt. %, at least 22 wt. %, at least 25 wt. %, at least 28 wt. %, at least 20 wt. %, at least 32 wt. %, or at least 34 wt. % for the total weight of the secondary phase; and/or wherein C_{P2CaO} is not greater than 41 wt. %, not greater than 39 wt. %, not greater than 36 wt. %, not greater than 34 wt. %, not greater than 32 wt. %, not greater than 30 wt. %, not greater than 27 wt. %, not greater than 25 wt. %, not greater than 23 wt. %, not greater than 20 wt. %, not greater than 18 wt. %, or not greater than 15 wt. % for the total weight of the secondary phase.

Embodiment 23. The ceramic article of any one of embodiments 18 to 22, wherein the secondary phase comprises a content of SiO₂, C_{P2SiO2}, in the secondary phase, wherein C_{P2SiO2} is at least 35 wt. %, at least 38 wt. %, at least 40 wt. %, at least 42 wt. %, at least 45 wt. %, at least 47 wt. %, at least 49 wt. %, at least 60 wt. %, or at least 62 wt. % for the total weight of the secondary phase; and/or wherein C_{P2SiO2} is not greater than 70 wt. %, not greater than 69 wt. %, not greater than 67 wt. %, not greater than 64 wt. %, not greater than 62 wt. %, not greater than 60 wt. %, not greater 57 wt. %, not greater than 54 wt. %, not greater than 51 wt. %, not greater than 48 wt. %, not greater than 45 wt. %, or not greater than 44 wt. % for the total weight of the secondary phase.

Embodiment 24. The ceramic article of any one of embodiments 18 to 23, wherein the secondary phase comprises a ratio, C_{P2Ca/Mg}, of C_{P2CaO} to C_{P2MgO}, wherein C_{P2CaO} is a content of CaO in the secondary phase, and C_{P2MgO} is a content of MgO in the secondary phase, wherein C_{P2Ca/Mg} is greater than 1, at least 1.2, at least 1.5, at least 1.7, at least 1.9, at least 2.1, at least 3.3, at least 2.5, at least 2.7, at least 3, at least 3.3, at least 3.5, at least 3.7, at least 3.9, at least 4.0, or at least 4.1; and/or wherein C_{P2Ca/Mg}, is not greater than 6.5, not greater than 6.3, not greater than 6.1, not greater than 5.9, not greater than 5.7, not greater than 5.5, not greater than 5.3, not greater 5.1, not greater than 4.8, not greater than 4.6, not greater than 4.3, or not greater than 4.1.

Embodiment 25. The ceramic article of any one of embodiments 18 to 24, wherein the secondary phase comprises a ratio, C_{P2Si/Mg}, of C_{P2SiO2} to C_{P2MgO}, wherein C_{P2SiO2} is a content of SiO₂ in the secondary phase, C_{P2MgO} is a content of MgO in the secondary phase, wherein C_{P2Si/Mg} is greater than 3.6, greater than 5.5, at least 5.6, at least 5.7, at least 5.8, at least 5.9, or at least 6; and/or wherein C_{P2Si/Mg} is less than 14, less than 11, not greater than 10, not greater than 9, not greater than 8, not greater than 7, or not greater than 6.

Embodiment 26. The ceramic article of any one of embodiments 18 to 25, wherein the secondary phase comprises a ratio, C_{P2Si/Ca}, of C_{P2SiO2} to C_{P2CaO}, wherein C_{P2SiO2} is a content of SiO₂ in the secondary phase, and C_{P2CaO} is a content of CaO in the secondary phase, wherein C_{P2Si/Ca} is at least 1.2, at least 1.4, at least 1.6, at least 1.8, at least 2.1, at least 2.4, at least 2.6, at least 2.8, at least 3.2, at least 3.5, at least 3.8, at least 4.0, or at least 4.2; and/or wherein C_{P2Si/CaMg} is not greater than 10, not greater than 9, not greater than 8, not greater than 7, not greater than 6, not greater than 5; or not greater than 4.

Embodiment 27. The ceramic article of any one of embodiments 18 to 26, wherein the secondary phase comprises a content of alumina (Al₂O₃), C_{P2Al2O3}, in the secondary phase, wherein C_{P2Al2O3} is at least 5 wt. %, at least 7 wt. %, at least 9 wt. %, at least 11 wt. %, or at least 15 wt. % in the secondary phase; and/or wherein C_{P2MgO} is not greater than 22 wt. % for the total weight of the secondary phase, not greater than 20 wt. %, not greater than 18 wt. %, not greater than 16 wt. %, not greater than 15 wt. %, not greater than 14 wt. %, not greater than 13 wt. %, not greater than 12 wt. %, not greater than 11 wt. %, or not greater than 10 wt. % for the total weight of the secondary phase.

Embodiment 28. The ceramic article of any one of embodiments 18 to 27, wherein the secondary phase comprises a ratio, C_{P2Al/Ca}, of C_{P2Al2O3} to C_{P2CaO}, wherein C_{P2Al2O3} is a content of alumina (Al₂O₃) in the secondary phase, and C_{P2CaO} is a content of CaO in the secondary phase, wherein C_{P2Al/Ca} is at least 0.3, at least 0.4, at least 0.5, at least 0.6, at least 0.7, at least 0.8, at least 0.9, at least 1, at least 1.1, or at least 1.2; and/or wherein C_{P2Si/CaMg} is not greater than 1.7, not greater than 1.5, not greater than 1.3, not greater than 1.2, not greater than 1.1, not greater than 1, not greater than 0.9, not greater than 0.8, not greater than 0.7, not greater than 0.6, or not greater than 0.5.

Embodiment 29. The ceramic article of any one of embodiments 18 to 28, wherein the secondary phase comprises a ratio, C_{P2Al/Mg}, of C_{P2Al2O3} to C_{P2MgO}, wherein C_{P2Al2O3} is a content of Al₂O₃ in the secondary phase, C_{P2MgO} is a content of MgO in the secondary phase, wherein C_{P2Al/Mg} is at least 1, at least 1.1, at least 1.2, at least 1.3, at least 1.4, at least 1.5, at least 1.6, at least 1.7, at least 1.8, or at least 1.9; and/or wherein C_{P2Si/Mg} is not greater than 2.6, not greater than 2.5, not greater than 2.4, not greater than 2.2, not greater than 2.1, not greater than 2, not greater than 1.9, not greater than 1.8, not greater than 1.7, not greater than 1.6, not greater than 1.5, or not greater than 1.4.

Embodiment 30. The ceramic article of any one of embodiments 18 to 29, wherein the secondary phase comprises a ratio, C_{P2Si/Al}, of C_{P2SiO2} to C_{P2CaO}, wherein C_{P2SiO2} is a content of SiO₂ in the secondary phase, and C_{P2Al2O3} is a content of Al₂O₃ in the secondary phase, wherein C_{P2Si/Al} is at least 2, at least 2.4, at least 2.6, at least 2.8, at least 2.9, at least 3, at least 3.1, at least 3.2, at least 3.3, at least 3.4, at least 3.5, at least 3.6, at least 3.8, at least 4.0, or at least 4.1; and/or wherein C_{P2Si/CaMg} is not greater than 5, not greater than 4.8, not greater than 4.6, not greater than 4.4, not greater than 4.2, not greater than 4.1, not greater than 4, not greater than 3.8, not greater than 3.7, not greater than 3.6, not greater than 3.5, not greater than 3.4, not greater than 3.3, not greater than 3.2, not greater than 3.1, or not greater than 3.

Embodiment 31. The ceramic article of any one of embodiments 1 to 30, wherein the body comprises a secondary phase comprising the amorphous phase and one or more secondary crystalline phases, wherein a total content of the secondary phase is at least 5 wt. % for the weight of the body, at least 7 wt. %, at least 9 wt. %, at least 10 wt. %, at least 11 wt. %, at least 12 at %, at least 13 wt. %, at least 14 wt. %, at least 15 wt. %, or at least 16 wt. % for the weight of the body; and/or wherein the total content of the secondary phase is not greater than 35 wt. % for the weight of the body, not greater than 30 wt. %, not greater than 25 wt. %, not greater than 22 wt. %, not greater than 20 wt. %, not greater than 18 wt. %, not greater than 16 wt. %, not greater than 14 wt. %, not greater than 12 wt. %, not greater than 10 wt. %, not greater than 9 wt. %, not greater than 8 wt. %, not greater than 7 wt. %, or not greater than 6 wt. %.

Embodiment 32. The ceramic article of any one of embodiments 1 to 31, wherein the content of the amorphous phase is at least 6.8 vol %, at least 6.9 vol %, at least 7 vol %, at least 7.2 vol %, at least 7.5 vol %, at least 7.7 vol %, at least 7.9 vol %, at least 8 vol %, at least 8.2 vol %, at least 8.4 vol %, at least 8.5 vol %, at least 8.7 vol %, at least 8.8 vol %, at least 9 vol %, at least 9.2 vol %, at least 9.4 vol %, at least 9.5 vol %, at least 9.6 vol %, at least 9.8 vol %, at least 9.9 vol %, at least 10 vol %, at least 10.2 vol %, at least 10.3 vol %, at least 10.4 vol %, or at least 10.5 vol % for the volume of the body; and/or wherein the content of the amorphous phase is not greater than 17.5 vol %, not greater than 16 vol %, not greater than 15.5 vol %, not greater than 14 vol %, not greater than 13.5 vol %, not greater than 12 vol %, not greater than 11 vol %, not greater than 10.5 vol %, or not greater than 10 vol % for the volume of the body.

Embodiment 33. The ceramic article of any one of embodiments 1 to 32, wherein the body comprises a total content of crystalline phases of not greater than 93.3 vol % for the volume of the body, not greater than 93 vol %, not greater than 92.5 vol %, not greater than 92 vol %, not greater than 91.5 vol %, not greater than 91 vol %, not greater than 90.5 vol %, not greater than 90 vol %, not greater than 89 vol %, not greater than 88 vol %, not greater than 87 vol %, not greater than 86 vol %, not greater than 85 vol %, not greater than 84 vol %, not greater than 83 vol %, or not greater than 82 vol % for the total volume of the body; and/or wherein the body comprises a total content of crystalline phases, C_{TC}, of at least 78 vol % for the volume of the body, at least 79 vol %, at least 80 vol %, at least 81 vol %, at least 82 vol %, at least 83 vol %, at least 84 vol %, at least 85 vol %, at least 85.5 vol %, at least 86.5 vol %, at least 87 vol %, at least 88 vol %, at least 88.5 vol %, at least 89 vol %, at least 89.5 vol %, at least 90 vol %, at least 90.5 vol %, at least 91 vol %, at least 91.5 vol %, or at least 92 vol % for the volume of the body.

Embodiment 34. The ceramic article of any one of embodiments 1 to 33, wherein the body comprises a secondary crystalline phase comprising hibonite, wherein the secondary crystalline phase comprising hibonite is in a content of at least 1 wt. % for a total weight of crystalline phases, at least 1.5 wt. %, at least 2 wt. %, at least 2.5 wt. %, at least 3.0 wt. %, at least 3.5 wt. %, or at least 4 wt. % for the total weight of crystalline phases; and/or wherein the secondary crystalline phase comprising hibonite is in a content of not greater than 7 wt. % for the total weight of crystalline phases, not greater than 6 wt. %, not greater than 5.5 wt. %, not greater than 5 wt. %, or not greater than 4.5 wt. % for the total weight of crystalline phases.

Embodiment 35. The ceramic article of any one of embodiments 1 to 34, wherein the body comprises a secondary crystalline phase comprising anorthite, wherein the secondary crystalline phase comprising anorthite is in a content of at least 3 wt. % for a total weight of crystalline phases, at least 3.5 wt. %, at least 4 wt. %, at least 4.5 wt. %, at least 5.0 wt. %, at least 5.5 wt. %, at least 6 wt. %, or at least 6.5 wt. % for the total weight of crystalline phase; and/or wherein the secondary crystalline phase comprising anorthite is in a content of not greater than 10 wt. % for the total weight of crystalline phases, not greater than 9.5 wt. %, not greater than 8.5 wt. %, not greater than 8 wt. %, not greater than 7.5 wt. %, or not greater than 7 wt. % for the total weight of crystalline phases.

Embodiment 36. The ceramic article of any one of embodiments 1 to 35, wherein the body comprises a secondary crystalline phase comprising gehlenite, wherein the secondary crystalline phase comprising gehlenite is in a content of at least 0.5 wt. % for a total weight of crystalline phases, at least 1 wt. % at least 1.5 wt. %, at least 2 wt. %, at least 2.5 wt. %, or at least 3 wt. % for the total weight of crystalline phases; and/or wherein the secondary crystalline phase comprising gehlenite is in a content of not greater than 7 wt. % for the total weight of crystalline phases, not greater than 6.5 wt. %, not greater than 5.5 wt. %, not greater than 5 wt. %, not greater than 4.5 wt. %, or not greater than 4 wt. % for the total weight of crystalline phases.

Embodiment 37. The ceramic article of any one of embodiments 1 to 36, wherein the body comprises a secondary crystalline phase comprising spinel, wherein the secondary crystalline phase comprising spinel is in a content of at least 0.5 wt. % for a total weight of crystalline phases, at least 1 wt. %, at least 1.5 wt. %, at least 2 wt. %, at least 2.5 wt. %, or at least 3 wt. % for the total weight of crystalline phases; and/or wherein the secondary crystalline phase comprising spinel is in a content of not greater than 5 wt. % for the total weight of crystalline phases, not greater than 4.5 wt. %, not greater than 4 wt. %, not greater than 3.5 wt. %, not greater than 3 wt. %, or not greater than 2.5 wt. % for the total weight of crystalline phases.

Embodiment 38. The ceramic article of any one of embodiments 1 to 37, wherein the body comprises a primary phase comprising corundum, wherein the primary phase is in a content of at least 80 wt. % for a total weight of crystalline phases, at least 82 wt. %, at least 83 wt. %, at least 84 wt. %, at least 85 wt. %, or at least 86 wt. % for the total weight of crystalline phase; and/or wherein the primary phase is in the content of not greater than 92 wt. % for the total weight of crystalline phases, not greater than 90 wt. %, not greater than 89 wt. %, not greater than 88 wt. %, not greater than 87 wt. %, not greater than 86 wt. %, or not greater than 85 wt. % for the total weight of crystalline phases.

Embodiment 39. The ceramic article of any one of embodiments 1 to 38, wherein the body comprises a content of the amorphous phase, C_{bG}, of at least 0.5 wt. % for the weight of the body, at least 0.8 wt. %, at least 1 wt. %, at least 3 wt. %, at least 5 wt. %, at least 7 wt. %, at least 8 wt. %, at least 9 wt. %, at least 10 wt. %, at least 12 wt. %, at least 13 wt. %, at least 14 wt. %, at least 15 wt. %, at least 16 wt. %, at least 17 wt. %, at least 18 wt. %, at least 19 wt. %, at least 20 wt. %, at least 21 wt. %, at least 22 wt. %, at least 23 wt. %, at least 24 wt. %, or at least 25 wt. % for the weight of the body; and/or wherein C_{bG} is not greater than 30 wt. %, not greater than 27 wt. %, not greater than 25 wt. %, not greater than 22 wt. %, not greater than 20 wt. %, not greater than 18 wt. %, not greater than 16 wt. %, not greater than 15 wt. %, not greater than 14 wt. %, not greater than 13 wt. %, not greater than 12 wt. %, not greater than 11 wt. %, or not greater than 10 wt. % for the weight of the body.

Embodiment 40. The ceramic article of any one of embodiments 1 to 39, wherein the body comprises a total content of crystalline phases, C_{TC}, of not greater than 99 wt. % for the weight of the body, not greater than 95 wt. %, not greater than 92 wt. %, not greater than 90 wt. %, not greater than 88 wt. %, not greater than 86 wt. %, not greater than 84 wt. %, not greater than 82 wt. %, or not greater than 81 wt. % for the weight of the body; and/or wherein the body comprises a total content of crystalline phases, C_{TC}, of at least 73 wt. % for the weight of the body, at least 75 wt. %, at least 77 wt. %, at least 80 wt. %, at least 82 wt. %, at least 84 wt. %, at least 86 wt. %, at least 88 wt. %, or at least 90 wt. % for the weight of the body.

Embodiment 41. The ceramic article of any one of embodiments 1 to 40, wherein the body comprises a ratio, C_{bTC/G}, of C_{TC} to C_{bG}, wherein C_{TC} is a total content of crystalline phases for the weight of the body, and C_{bG} is a content of the amorphous phase for the weight of the body, wherein C_{bTC/G} is at least 1.5, at least 3, at least 4, at least 5, at least 6, at least 7, at least 8, at least 9, at least 10, at least 11, at least 12, at least 13, at least 14, at least 15, or at least 16; and/or where C_{bTC/G} is not greater than 30, not greater than 29, not greater than 27, not greater than 25, not greater than 24, not greater than 22, not greater than 20, not greater than 19, not greater than 18, not greater than 17, not greater than 16, not greater than 15, not greater than 14, not greater than 13, not greater than 12, or not greater than 11.

Embodiment 42. The ceramic article of any one of embodiments 1 to 41, wherein the body comprises a ratio, C_{P2TC/G}, of C_{P2TC} to C_{P2TC}, wherein C_{P2TC} is a total content of secondary crystalline phases for the weight of the body, and C_{bG} is a content of the amorphous phase for the weight of the body, wherein C_{P2TC/G} is at least 0.01, at least 0.03, at least 0.05, at least 0.08, at least 0.1, at least 0.2, at least 0.3, at least 0.4, at least 0.5, at least 0.6, at least 0.7, at least 0.8, at least 0.9, at least 1, at least 1.3, at least 1.5, at least 1.7, at least 2, at least 2.3, at least 2.5, at least 2.8, at least 3, at least 3.4, at least 3.8, at least 4, at least 4.5, at least 4.8, at least 5, at least 5.2, at least 5.5, at least 5.7, at least 5.9, at least 6.2, at least 6.5, at least 6.8, at least 7, at least 7.3, at least 7.5, at least 7.8, at least 8.2, at least 8.5, at least 8.7, at least 8.9, at least 9.2, at least 9.4, at least 9.6, at least 9.8, at least 10.0, or at least 11; and/or where the ratio C_{P2TC}/G is not greater than 20, not greater than 18, not greater than 16, not greater than 14, not greater than 12, not greater than 10, not greater than 9.8, not greater than 9.5, not greater than 9.2, not greater than 9.0, not greater than 8.8, not greater than 8.5, not greater than 8.2, not greater than 8.0, not greater than 7.7, not greater than 7.5, not greater than 7.3, not greater than 7.1, not greater than 6.8, not greater than 6.5, not greater than 6.3, not greater than 6.1, not greater than 5.8, not greater than 5.5, not greater than 5.3, not greater than 5.1, not greater than 4.8, not greater than 4.5, not greater than 4.3, not greater than 4.1, not greater than 3.8, not greater than 3.5, not greater than 3.3, not greater than 3.1, not greater than 2.8, not greater than 2.5, not greater than 2.3, not greater than 1.9, not greater than 1.7, not greater than 1.5, not greater than 1.3, not greater than 1.1, not greater than 1.0, not greater than 0.9, not greater than 0.8, not greater than 0.7, not greater than 0.6, not greater than 0.5, not greater than 0.4, not greater than 0.3, not greater than 0.2, not greater than 0.1, not greater than 0.08, not greater than 0.06, not greater than 0.03, or not greater than 0.01.

Embodiment 43. The ceramic article of any one of embodiments 1 to 42, wherein the body comprises a total content of secondary crystalline phases of at least 5 wt. % for the weight of the body, at least 6 wt. %, at least 7 wt. %, at least 8 wt. %, at least 9 wt. %, at least 10 wt. %, at least 11 wt. %, at least 12 wt. %, at least 13 wt. %, at least 14 wt. %, at least 15 wt. %, or at least 16 wt. % for the weight of the body; and/or wherein the body comprises a total content of secondary crystalline phases of not greater than 25 wt. %, not greater than 22 wt. %, not greater than 20 wt. %, not greater than 19 wt. %, not greater than 18 wt. %, not greater than 17 wt. %, not greater than 16.5 wt. % not greater than 16 wt. %, not greater than 15.5 wt. %, not greater than 15 wt. %, not greater than 14.5 wt. %, not greater than 14 wt. %, not greater than 13.5 wt. %, not greater than 13 wt. %, not greater than 12.5 wt. %, or not greater than 12 wt. % for the weight of the body.

Embodiment 44. The ceramic article of any one of embodiments 1 to 43, wherein the body comprises a porosity of not greater than 15 vol % for the volume of the body, not greater than 13 vol %, not greater than 11 vol %, not greater than 10 vol %, not greater than 9 vol %, not greater than 8 vol %, not greater than 7 vol %, not greater than 6 vol %, not greater than 5 vol %, not greater than 4 vol %, not greater than 3 vol %, not greater than 2 vol %, not greater than 1 vol %, or not greater than 0.5 vol % for the volume of the body.

Embodiment 45. The ceramic article of any one of embodiments 1 to 44, wherein the body comprises a density at least 3.51 g/cm³, at least 3.52 g/cm³, at least 3.53 g/cm³, at least 3.55 g/cm³, at least 3.56 g/cm³, at least 3.57 g/cm³, at least 3.58 g/cm³, at least 3.59 g/cm³, at least 3.60 g/cm³, at least 3.61 g/cm³, at least 3.62 g/cm³, at least 3.63 g/cm³, or at least 3.64 g/cm³; and or wherein the density is not greater than 3.67 g/cm³, not greater than 3.66 g/cm³, not greater than 3.65 g/cm³, not greater than 3.64 g/cm³, not greater than 3.63 g/cm³, not greater than 3.62 g/cm³, not greater than 3.61 g/cm³, not greater than 3.60 g/cm³, not greater than 3.59 g/cm³, not greater than 3.58 g/cm³, not greater than 3.57 g/cm³, not greater than 3.56 g/cm³, not greater than 3.55 g/cm³, not greater than 3.54 g/cm³, not greater than 3.53 g/cm³, or not greater than 3.52 g/cm³.

### EXAMPLES

### Example 1

Ceramic Samples S20 and S21 are formed having the same composition included in Table 1. The mixtures and green bodies for forming the samples are made as described in embodiments herein. The green bodies are fired and cooled as noted in Tables 2 and 3. The contents of the oxides are relative to the total weight of the finally-formed body.

TABLE 1

| | S20/S21 |
|---|---|
| Al₂O₃ wt. % | 91 |
| SiO₂ wt. % | 4.57 |
| MgO wt. % | 0.817 |
| CaO wt. % | 3.29 |
| BaO wt. % | 0.02 |
| Na₂O wt. % | 0.197 |
| K₂O wt. % | 0.013 |
| Fe₂O₃ wt. % | 0.026 |
| TiO₂ wt. % | 0.031 |
| ZrO₂ wt. % | 0.004 |

Samples S20 are fired and cooled as noted in Table 2 below.

TABLE 2

| Temperature | Rate (° C./min) | Dwell time (min) |
|---|---|---|
| From 20° C. to 600° C. | 1 | / |
| 600° C. | / | 60 |
| From 600° C. to 1500° C. | 2 | / |
| 1500° C. | / | 360 |
| From 1500° C. to 1120° C. | −0.6 | / |
| From 1120° C. to 500° C. | −2 | / |
| From 500° C. to 20° C. | Furnace cool | / |

Samples S21 are fired and cooled as noted in Table 3 below.

TABLE 3

| Temperature | Rate (° C./min) | Dwell time (min) |
|---|---|---|
| From 20° C. to 600° C. | 1 | / |
| 600° C. | / | 60 |
| From 600° C. to 1500° C. | 2 | / |
| 1500° C. | / | 360 |
| From 1500° C. to 1200° C. | −10-11 | / |
| From 1200° C. to 20° C. | Furnace cool | / |

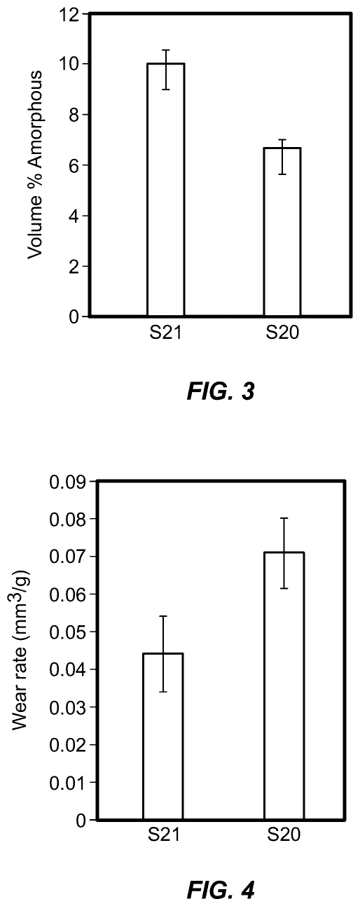

Samples S20 and S21 were analyzed for contents of amorphous phases using EBSD analysis followed by digital image analysis as noted in embodiments herein. An average amorphous phase content based on 5 samples is illustrated for both Samples S20 and S21 in FIG. 3. Samples S21 have an amorphous phase content of 9-11 vol % in the bodies of the samples, while Samples S20 have an amorphous phase content of 5-7 vol % and an averaged content of approximately 6.5 vol %.

Samples S20 and S21 have similar density of approximately 3.596 g/cm³ and were tested for wear rates according to ASTM G76. As illustrated in FIG. 4, Samples S21 demonstrated an average wear rate of about 0.042 mm³/g, and Samples S20 demonstrated a wear rate of about 0.071 mm³/g.

The foregoing embodiments represent a departure from the state-of-the-art. Embodiments are directed to ceramic articles including a body having a primary phase including alumina and an amorphous phase at a particular content. In particular, the ceramic articles can have improved performance such as wear rates, which may be facilitated by the composition of the ceramic article, particular forming process, or any combination thereof. For example, contents of one or more secondary phases, contents of oxides and/or ratios there between, contents of the primary phase, heating and/or cooling control and/or the secondary composition for forming the ceramic article, or any combination thereof may facilitate improved performance of the ceramic articles.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include a range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A ceramic article, comprising a body comprising:
at least 83 wt. % of alumina (Al₂O₃) for a weight of the body;
a content of CaO, C_{bCaO}, for the weight of the body; and
a content of MgO, C_{bMgO}, for the weight of the body, wherein a ratio, C_{bCa/Mg}, of C_{bCaO} to C_{bMgo}, is greater than 1,
wherein the body comprises an amorphous phase of at least 6.7 vol % for a volume of the body.

2. The ceramic article of claim 1, wherein the ratio, C_{bCa/Mg}, is at least 2.1 and not greater than 5.2.

3. The ceramic article of claim 1, wherein the content of CaO, C_{bCaO}, is greater than 2.5 wt. % and not greater than 9 wt. %.

4. The ceramic article of claim 1, wherein the body comprises a content of SiO₂, C_{bSiO2}, of less than 7 wt. % for the weight of the body.

5. The ceramic article of claim 1, wherein the body comprises alumina grains having an average grain size of greater than 2 microns, a maximum grain size greater than 6 microns, or a combination thereof.

6. The ceramic article of claim 1, wherein the body comprises a primary phase comprising crystalline alumina (Al₂O₃), wherein the primary phase is at least 70 wt. % and not greater than 93 wt. % for the weight of the body.

7. The ceramic article of claim 1, wherein the body comprises a secondary phase comprising the amorphous phase, and wherein the secondary phase comprises for a total weight of the secondary phase:
a content of MgO, C_{P2MgO}, of greater than 5 wt. % and less than 15 wt. %;
a content of CaO, C_{P2CaO}, of at least 6 wt. % and not greater than 41 wt. %;
a content of SiO₂, C_{P2SiO2}, of at least 35 wt. % and not greater than 70 wt. %;
a content of Al₂O₃, C_{P2Al2O3}, of at least 5 wt. % and not greater than 22 wt. %; or
any combination thereof.

8. A ceramic article, comprising a body comprising:
at least 83 wt. % of alumina (Al₂O₃) for a weight of the body; and
a content of CaO, C_{bCaO}, of greater than 2.5 wt. % for the weight of the body;
wherein the body comprises an amorphous phase of at least 6.7 vol % for a volume of the body.

9. The ceramic article of claim 8, wherein the body comprises for the weight of the body, a content of MgO, C_{bMgO}, wherein a ratio of C_{bCaO} to C_{bMgo}, C_{bCa/Mg}, is greater than 1 and not greater than 5.2.

10. The ceramic article of claim 8, wherein the body comprises for the weight of the body:
a content of MgO, C_{bMgO}, of at least 0.4 wt. % and less than 1.9 wt. %;
a content of SiO₂, C_{bSiO2}, of at least 2.3 wt. % and less than 7 wt. %; or
any combination thereof.

11. The ceramic article of claim 8, wherein the body comprises a primary phase comprising crystalline alumina (Al₂O₃) and a secondary phase comprising the amorphous phase and one or more secondary crystalline phases.

12. The ceramic article of claim 11, wherein the one or more secondary crystalline phases comprise spinel (MgAl₂O₄), hibonite ((Al, Ti, Mg)₁₂O₁₉), anorthite (CaAl₂Si₂O₈), gehlenite (Ca₂Al(SiAl)O₇), or any combination thereof.

13. The ceramic article of claim 8, wherein the amorphous phase is at least 8 vol % and not greater than 17.5 vol %.

14. A ceramic article, comprising a body comprising:
alumina (Al₂O₃) of at least 83 wt. % for a weight of the body, wherein grains of alumina have an average grain size of greater than 2 microns and a maximum grain size greater than 6 microns; and
at least one of CaO and MgO,
wherein the body comprises an amorphous phase of at least 6.7 vol % for a volume of the body.

15. The ceramic article of claim 14, wherein the body comprises for the weight of the body, a content of MgO, C_{bMgo}, and a content of CaO, C_{bCaO}, wherein a ratio of C_{bCaO} to C_{bMgo}, C_{bCa/Mg}, is at least 2.1 and not greater than 5.2.

16. The ceramic article of claim 15, wherein the content of CaO is greater than 2.5 wt. % and not greater than 9 wt. % for the weight of the body.

17. The ceramic article of claim 14, wherein the body comprises a content of SiO₂, C_{bSiO2}, of less than 7 wt. % for the weight of the body.

18. The ceramic article of claim 14, wherein a ratio, C_{bSi/Ca}, of C_{bSiO2} to C_{bCaO} is not greater than 7.5 and at least 0.3, wherein C_{bSiO2} is a content of SiO₂ for the weight of the body, and C_{bCaO} is a content of CaO for the weight of the body.

19. The ceramic article of claim 14, wherein the body comprises a primary phase comprising crystalline alumina (Al₂O₃) and a secondary phase comprising an oxide comprising an alkaline earth metal oxide, an alkali metal oxide, Al₂O₃, SiO₂, TiO₂, Fe₂O₃, ZrO₂, or any combination thereof.

20. The ceramic article of claim 19, wherein the secondary phase comprises:
a ratio, C_{P2Ca/Mg}, of C_{P2CaO} to C_{P2MgO}, greater than 1, wherein C_{P2CaO} is a content of CaO in the secondary phase, and C_{P2MgO} is a content of MgO in the secondary phase;
a ratio, C_{P2Si/Mg}, of C_{P2SiO2} to C_{P2MgO}, of greater than 3.6 and less than 14, wherein C_{P2SiO2} is a content of SiO₂ in the secondary phase;
a ratio, C_{P2Si/Ca}, of C_{P2SiO2} to C_{P2CaO}, of at least 1.2;
a ratio, C_{P2Al/Ca}, of C_{P2Al2O3} to C_{P2CaO}, of at least 0.3, wherein C_{P2Al2O3} is a content of Al₂O₃ in the secondary phase;
a ratio, C_{P2Al/Mg}, of C_{P2Al2O3} to C_{P2MgO}, of at least 1,
a ratio, C_{P2Si/Al}, of C_{P2SiO2} to C_{P2Al2O3} of at least 2; or
any combination thereof.
